(19) United States
(12) Patent Application Publication
(10) Pub. No.: US 2024/0224959 A1
(43) Pub. Date: Jul. 11, 2024

(54) LUMINAIRE FOR AN AQUACULTURE SYSTEM

(71) Applicant: SIGNIFY HOLDING B.V., EINDHOVEN (NL)

(72) Inventors: MARCELLINUS PETRUS CAROLUS MICHAEL KRIJN, EINDHOVEN (NL); MASSIMO TUMOLO, UTRECHT (NL); SRI ANDARI HUSEN, EINDHOVEN (NL); LAMBERTUS ANTONIUS JOHANNES VAN DE WIJDEVEN, SINT OEDENRODE (NL)

(21) Appl. No.: 18/558,791

(22) PCT Filed: May 10, 2022
(86) PCT No.: PCT/EP2022/062550

§ 371 Date: Nov. 3, 2023

(30) Foreign Application Priority Data
May 11, 2021 (EP) 21173194.8

(51) Int. Cl. A01K 63/06; A01K 29/00; A01K 61/10

(52) U.S. Cl. CPC A01K 63/06; A01K 29/005; A01K 61/10

(57) ABSTRACT

This disclosure relates to a submersible luminaire for an aquaculture lighting system and a controller for controlling the luminaire. The aquaculture lighting system is configured to influence physiological development of fish in an enclosed area. The luminaire comprises a luminaire housing. Further, the luminaire housing accommodates a grow light source configured to generate grow light suitable for influencing physiological development of fish and an anti-fouling light source configured to generate anti-fouling light suitable for preventing biological fouling on and/or removing biological fouling from a surface, wherein the grow light source and the anti-fouling light source are separately controllable. The luminaire housing further comprises a transmissive part comprising a first side adjacent to an interior of the luminaire housing and a second side adjacent to an environment outside of the luminaire housing. The transmissive part of the luminaire housing is at least partially transparent for the grow light and for the anti-fouling light. The controller is adapted to separately control the grow light source and the anti-fouling light source to thereby independently influence physiological development of fish and prevent biological fouling on and/or remove biological fouling from the second side of the transmissive part.

### FIELD OF THE INVENTION

This disclosure relates to a submersible luminaire for an aquaculture lighting system. In particular to such aquaculture systems that comprise a luminaire housing accommodating a grow light source and an anti-fouling light source. This disclosure further relates to a method for controlling a luminaire and to a control system and computer program for such method.

### BACKGROUND

Aquaculture, such as salmon farming, is gaining considerable importance in feeding the world in a sustainable manner. In fish farms, fish are typically grown in ponds in large stationary cages in open waters, e.g. in fjords, or in closed systems, until the fish reach a certain maturity as requested by the market.

It is known that lamps can be used in aquaculture farming that are submersed and that prevent the fish to notice the shortening of the days. By doing so, sexual maturation is delayed, with the effect of increased growth, improved feed conversion efficiency and improved product quality. (Good, C. and Davidson, J. (2016), A Review of Factors Influencing Maturation of Atlantic Salmon, Salmo salar, with Focus on Water Recirculation Aquaculture System Environments. J World Aquacult Soc, 47: 605-632.) and (Aksnes et al. Biological, chemical and organoleptic changes during maturation of farmed Atlantic salmon, Salmo salar, Aquaculture, Volume 53, Issue 1, 1986, Pages 7-2).

In the context of providing artificial light to fish, the so-called light recipe is an important concept. The light recipe typically defines which type of light the fish receive, e.g. which light color and which intensity, and typically defines when the fish receive such light. Fish farmers continuously strive to design the optimum light recipe that yields the best results in terms of development and growth of the fish.

One challenge of working with submersed aquaculture lighting systems is that biofouling typically accumulates on a submersed system. If biofouling is present on an exit window of a luminaire, then this may influence, reduce, the irradiance as output by the luminaire. As a consequence, fish may receive light that is not in accordance with some targeted light recipe. In other words, the biofouling may compromise the targeted light recipe. This is highly undesired as it may negatively impact the effectiveness with which the fish are grown in the fish farm.

Cleaning of the exit window can be done by taking the lamps out of the water or by divers cleaning the lamps underwater. Both methods are cumbersome.

In light of the above, there is a need in the art for an aquaculture system that is less prone to biofouling.

### SUMMARY

To that end, a submersible luminaire for an aquaculture lighting system is disclosed. The aquaculture lighting system is configured to influence physiological development of fish in an enclosed area. The luminaire comprises a luminaire housing. Further, the luminaire housing accommodates a grow light source configured to generate grow light suitable for influencing physiological development of fish and an anti-fouling light source configured to generate anti-fouling light suitable for preventing biological fouling on and/or removing biological fouling from a surface. The grow light source and the anti-fouling light source are separately controllable. The luminaire housing further comprises a transmissive part. The transmissive part comprises a first side adjacent to an interior of the luminaire housing and a second side adjacent to an environment outside of the luminaire housing. The transmissive part of the luminaire housing is at least partially transparent for the grow light and for the anti-fouling light.

Advantageously, the luminaire accommodates both the grow light source and the anti-fouling light source which are separately controllable. If biofouling has accumulated on the second side of the transmissive part, which may be understood as the side that is in contact with the underwater environment, then the anti-fouling light source may be controlled to generate the anti-fouling light. Herewith, the spectrum of the light emitted by the luminaire as a whole is (temporarily) adjusted. The anti-fouling light can pass through the transmissive part and reach the second side of the transmissive part where the biofouling is present. The anti-fouling light may remove the biofouling from the second side. As a result, the grow light generated by the grow light source in the luminaire housing is then no longer (partially) blocked by the biofouling, meaning that the grow light can reach the underwater environment—and propagate through it—as intended, so that the fish in the underwater environment receive a targeted light recipe. Using the luminaire housing to accommodate both the anti-fouling light source and the grow light source provides for a simple and efficient design. Because of this design, the anti-fouling light hits the biofouling where it is attached to the transmissive part, namely at the second side of the transmissive part. No matter how thick the biofouling layer has become, it can be attacked at the boundary between the biofouling and second side of the transmissive part. Of course, being able to remove biofouling at this boundary enables to cause even thick layers of biofouling to detach from the second side of transmissive part. For a lump of biofouling on an object to detach, only a relatively thin layer of the lump attached to the object need to be removed. The luminaire housing of the luminaire may be understood to protect—at the same time—both the grow light source and the anti-fouling light source from the underwater environment. Further, having the grow light source and the anti-fouling light source both inside the luminaire housing is advantageous because this allows to easily position the light sources such that the anti-fouling light passes through the same areas of the transmissive part as the grow light does. This allows to ensure that the biofouling is removed by the anti-fouling light from the areas of the transmissive part through which grow light actually also passes.

As used herein, a light source may be understood to refer to an element that produces light in the sense that the light is actually generated at the light source, as opposed to for example light being merely reflected at the light source. Preferably, the light source is configured to convert some form of energy, such as electrical energy, into light, i.e. into electromagnetic radiation. An example of a light source would be a Light Emitting Diode (LED).

The grow light may be suitable for influencing physical development of fish in the sense that it can prevent fish from noticing the shortening of the days.

The grow light source and anti-fouling light source and the transmissive part of the luminaire housing are preferably configured such that grow light generated by the grow light source transmits through the transmissive part and can reach fish swimming in the environment outside of the luminaire housing, preferably fish that are swimming at a couple of meters, such as four meters, distance from the luminaire housing, and are preferably configured such that anti-fouling light generated by the anti-fouling light source transmits through the transmissive part such that the anti-fouling light reaches the second side of the transmissive part such that the anti-fouling light prevents biological fouling from forming on the second side and/or removes biological fouling from the second side.

Biofouling or biological fouling may be understood as the accumulation of microorganisms, plants, algae, and/or small animals where it is not wanted on underwater surfaces.

In an embodiment, the anti-fouling light comprises ultraviolet light having a wavelength between 100-400 nm, preferably ultraviolet-C light having a wavelength between 100-280 nm, and/or blue light having a wavelength between 400-470 nm.

Such anti-fouling light can effectively kill or inactivate microorganisms in the biofouling by destroying nucleic acids and disrupting their DNA, leaving them unable to perform vital cellular functions. As a result, the biofouling detaches from the second side of the luminaire housing's transmissive part.

In an embodiment, the grow light comprises blue light having a wavelength between 400-470 nm and/or green light having a wavelength between 500-580 nm. Such grow light can effectively influence the physiological development of the fish.

A typical light spectrum of grow light contains blue light originating from blue-emitting LEDs at 450 nm. Part of the blue light may be converted into broadband green light, using for example a phosphor, with a peak emission at about 540 nm. Red light is typically absent from grow light.

In an embodiment, the transmissive part comprises quartz glass and/or borosilicate and/or lime glass and/or sapphire and/or Poly(methyl methacrylate).

UV-A transmitting materials are for example standard borosilicate or soda lime glasses. UV-B transmitting materials are for example certain types of soda lime glasses (such as 8405 or 8347 from the company Schott), Sapphire, and Poly(methyl methacrylate) (PMMA).

In an embodiment, the transmissive part comprises one or more laminates, wherein each laminate comprises at least two thin layers of different materials. Example of such laminate is a laminate comprising a layer of glass and a layer of PMMA.

In an embodiment, the luminaire is configured to cause the anti-fouling light as generated by the anti-fouling light source to have, at 0.5 meters distance from the luminaire in the environment outside the luminaire housing, a radiant power, e.g. a radiant power per surface area, that is not harmful for said fish.

This embodiment enables to achieve that anti-fouling light is not generated at too high radiant powers. Such high radiant powers may cause the anti-fouling light to harm fish that are swimming at some distance from the luminaire housing. Preferably, the anti-fouling light has, at 0.5 meters distance from the luminaire in the environment outside the luminaire housing, an irradiance flux density of at most 5 W/m².

In an embodiment, the luminaire is configured to cause the anti-fouling light as generated by the anti-fouling light source to have, at the second side of the transmissive part, a radiant power, e.g. a radiant power per surface area, sufficient for removing biological fouling from the second surface and/or sufficient for preventing biological fouling.

This embodiment enables to achieve that the anti-fouling light is generated at a high enough radiant power such that the biological fouling on the second side is effectively removed and/or prevented. Preferably, the anti-fouling light has, at the second side of the transmissive part, a radiant power of at least 0.1 W and/or an irradiance flux density of at least 1 W/m².

The radiant power per surface area may also be referred to as irradiance flux density having SI units W/m².

It should be appreciated that the radiant power of the anti-fouling light as generated by the anti-fouling light source may depend on the spectrum of the anti-fouling light. Some wavelength ranges may be more effective and/or more harmful to fish than other wavelength ranges.

In an embodiment, the luminaire is configured to cause the grow light as generated by the grow-light source to have, at 20 meters distance from the luminaire in the environment outside the luminaire housing, a radiant power, e.g. a radiant power per surface area, that is sufficient for influencing the physiological development of the fish.

This embodiment enables to achieve that the grow light reaches fish swimming at some distance from the luminaire housing while it still has enough radiant power to indeed influence the physiological development of the fish, e.g. to prevent the fish from noticing the shortening of the days. Preferably, at 20 meters distance from the luminaire, the grow light has an irradiance flux density of 2 W/m². Typically, at 0.5 meters distance from the luminaire, the grow light has an irradiance flux density of approximately 100 W/m².

It is readily understood that the radiant power of the anti-fouling light and/or grow-light at some position outside the luminaire housing, e.g. at the second side of the transmissive part, is influenced by the transmissive part, e.g. by its thickness and by the transmission characteristics of the material forming the transmissive part, and influenced by the radiant power of the anti-fouling light resp. grow light as generated by the light sources. Hence, the luminaire may be understood to be configured to cause the anti-fouling light and/or grow-light to have certain radiant powers at certain positions outside the luminaire housing if, given the properties of the transmissive part, such as thickness and material forming the transmissive part, the anti-fouling light source resp. grow light source can be controlled to generate anti-fouling light resp. grow light at suitable radiant powers.

One aspect of this disclosure relates to an aquaculture lighting system comprising a luminaire as described herein and a control system that is configured to separately control the grow light source and the anti-fouling light source to thereby independently influence physiological development of fish and prevent biological fouling and/or remove biological fouling.

The control system may for example be configured to control when the anti-fouling light source resp. grow light source generates anti-fouling light resp. grow light and/or configured to control a radiant power of the generated anti-fouling light resp. grow light. The control system may be configured to control when the anti-fouling light source resp. grow light source generates anti-fouling light resp. grow light in the sense that it is configured to control a frequency with which light pulses are generated and/or a duration of generated light pulses.

In an embodiment, the anti-fouling light source is configured to repeatedly generate anti-fouling light pulses. In such embodiment, preferably, the control system is configured to control a frequency of the anti-fouling light pulses and/or a duration of the anti-fouling light pulses and/or a radiant power of the anti-fouling light pulses.

In an embodiment, the control system is configured to control a radiant power of the anti-fouling light and/or to control when the anti-fouling light source generates anti-fouling light, such that biological fouling on the second side of the transmissive part is prevented.

This embodiment is advantageous in that it enables to prevent biological fouling from forming on the second side. With the absence of biological fouling, a desired light recipe can be provided to the fish at any given time. Further, prevention of biological fouling may require less radiant power and/or a lower light dose than removal of biological fouling. Hence, the risk of harming fish is reduced with this embodiment.

In an embodiment, the aquaculture lighting system comprises a biological fouling detector for detecting biological fouling on the second side of the transmissive part.

In this embodiment, the control system is configured to receive one or more signals from the biological fouling detector indicative of biological fouling on the second side of the transmissive part, and to based on the one or more signals received from the biological fouling detector, control the anti-fouling light source to generate anti-fouling light for removing the detected biological fouling from the second side of the transmissive part.

This embodiment enables to generate anti-fouling light only when necessary. Herewith, the risk of harming fish is greatly reduced as well as power consumption of the aquaculture lighting system.

The one or more signals may indicate whether biological fouling is present on the second side. Additionally or alternatively, the one or more signals may indicate how much biological fouling is present on the second side.

It should be appreciated that controlling the anti-fouling light source to generate anti-fouling light may be embodied as increasing the radiant power of the anti-fouling light as generated from a nonzero radiant power to a higher radiant power.

Alternatively, controlling the anti-fouling light source to generate anti-fouling light may be embodied as initiating the generation of anti-fouling light, thus increasing the radiant power of the anti-fouling light from zero to a nonzero radiant power.

In an embodiment, the biological fouling detector comprises a detection light source for generating detection light and arranged to couple said detection light into the transmissive part at an in-coupling surface. This embodiment also comprises a light detector for measuring detection light and arranged to measure said detection light exiting the transmissive part at an out-coupling surface. Herein, the transmissive part is configured such that at least a first part of the detection light propagates through the transmissive part via total internal reflection between the first and the second surface of the transmissive part. Biological fouling at the second surface of the transmissive part causes at least a second part of the detection light to scatter and exit the transmissive part.

This embodiment provides a convenient method of detecting biological fouling. In this embodiment, the one or more signals as output by the biological fouling detector may be indicative of the amount of detection light received by the light detector. In principle, the more detection light is received at the light detector, the less biological fouling is present on the second side of the transmissive part.

In an embodiment, the biological fouling detector comprises a filter for preventing grow light and/or anti-fouling light from reaching the light detector. This embodiment provides an even more accurate detection of biological fouling. The anti-fouling light and grow light may distort the biological fouling measurement if incident on the light detector.

In an embodiment, the aquaculture lighting system comprises a fish detection system for detecting fish near the luminaire. In this embodiment, the control system is configured to
receive one or more signals from the fish detection system indicating fish being present near and/or in front of the luminaire, and to
based on the received one or more signals from the fish detection system, control the anti-fouling light source by controlling a radiant power of the anti-fouling light as generated by the anti-fouling light source and/or by controlling when the anti-fouling light source generates anti-fouling light.

As used herein, fish being near the luminaire may be understood as that the fish are within a predetermined distance from the luminaire housing.

Preferably, the control system is configured to control the anti-fouling light source such that the anti-fouling light source generates anti-fouling light selectively at times when there are a limited number of fish near the luminaire and/or such that the anti-fouling light source increases the radiant power of the anti-fouling light as generated by the anti-fouling light source selectively at times when there are a limited number of fish near the luminaire. In an example, the control system comprises information indicating when there are a limited number of fish near the luminaire. The control system may then use this information to control the anti-fouling light as appropriate. This information may indicate when there are a limited number of fish near the luminaire in the sense that it indicates when feed is provided to the fish, e.g. by a fish feeding system, at a position where the fish cannot be harmed by the anti-fouling light.

Preferably, the anti-fouling light is only generated when most of the fish will not be illuminated and therefore will not be harmed (i.e. when the fish are swimming above the lamps, e.g. as determined by sonar or cameras).

In this embodiment, controlling the radiant power of the anti-fouling light preferably comprises lowering the radiant power of the anti-fouling light as generated by the anti-fouling light source or even switching off the anti-fouling light source based on the one or more signals from the fish detection system.

In an embodiment, the aquaculture lighting system comprises a fish feeding system for providing fish feed at a position, wherein the luminaire is configured such that anti-fouling light cannot reach said position or is at least configured to cause the anti-fouling light as generated by the anti-fouling light source to have at said position, a radiant power, e.g. a radiant power per surface area, that is not harmful for said fish. In an example, the luminaire is positioned under the water surface, for example somewhere between 2-8 meters under the water surface, and is configured such that, e.g. positioned such that, the anti-fouling light is directed downwards, whereas the fish feeding system is configured to provide feed to the fish at the water surface.

In such embodiment, the control system may be configured to receive one or more signals from the fish feeding system indicating that feed is being provided at said position, and to, based on the received one or more signals from the fish feeding system, control the anti-fouling light source by controlling a radiant power of the anti-fouling light as generated by the anti-fouling light source and/or by controlling when the anti-fouling light source generates anti-fouling light.

If fish feed is provided at said position, then there is a high probability that the fish are near that position and will therefore not receive a harmful dose of anti-fouling light if generated by the anti-fouling light source. In an embodiment, the control system is configured to cause the anti-fouling light source to initiate generating anti-fouling light and/or to increase the radiant power of the anti-fouling as generated in response to a signal from the fish feeding system indicating that feed is being provided at said position.

A distinct aspect of this disclosure relates to an, optionally computer-implemented, method for controlling a luminaire as disclosed herein. This method comprises controlling the grow light source of the luminaire to generate the grow light and the anti-fouling light source of the luminaire to generate the anti-fouling light, thereby independently influencing physiological development of fish and preventing biological fouling on and/or removing biological fouling from the second side of the transmissive part of the luminaire. This method may further comprise receiving one or more signals from a biological fouling detector configured to detect biological fouling on the second side of the transmissive part, said one or more signals from the biological fouling detection detector being indicative of biological fouling on the second side of the transmissive part, and, based on the one or more signals received from the biological fouling detector, controlling the anti-fouling light source to generate anti-fouling light for removing the detected biological fouling from the second side of the transmissive part. Additionally or alternatively this method may comprise receiving one or more signals from a fish detection system indicating fish being present near and/or in front of the luminaire, and, based on the received one or more signals from the fish detection system, controlling the anti-fouling light source by controlling a radiant power of the anti-fouling light as generated by the anti-fouling light source and/or by controlling when the anti-fouling light source generates anti-fouling light.

Further, the method may comprise any of the steps described in this disclosure that the control system described herein is configured to perform.

A distinct aspect of this disclosure relates to a control system for use in an aquaculture lighting system as described herein, wherein the control system comprises a data processing system configured to perform any of the methods for controlling a luminaire as disclosed herein.

The data processing system may comprise a computer readable storage medium having computer readable program code embodied therewith, and a processor, preferably a microprocessor, coupled to the computer readable storage medium, wherein responsive to executing the computer readable program code, the processor is configured to perform any of the methods for controlling a luminaire as disclosed herein.

A distinct aspect of this disclosure relates to a computer program comprising instructions which, when the program is executed by a data processing system of a control system described herein, cause the data processing system to perform any of the methods described herein for controlling a luminaire.

A distinct aspect of this disclosure relates to a non-transitory computer-readable storage medium storing any of the computer programs described herein.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided. A computer program may, for example, be downloaded (updated) to the existing control systems or be stored upon manufacturing of these systems.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 schematically depicts an aquaculture lighting system according to an embodiment, comprising a luminaire according to an embodiment;

FIG. 2 schematically depicts a luminaire according to an embodiment comprising a biological fouling detector;

FIG. 3 schematically illustrates an aquaculture system according to an embodiment comprising a fish detection system;

FIG. 4 is a flow chart illustrating a method according to an embodiment for controlling a luminaire that comprises controlling the anti-fouling light source based on one or more signals from a biofouling detector;

FIG. 5 is a flow chart illustrating a method according to an embodiment for controlling a luminaire that comprises controlling the anti-fouling light source based on one or more signals from a fish detection system;

FIG. 6 is a flow chart illustrating a method according to an embodiment for controlling a luminaire that comprises controlling the anti-fouling light source based on one or more signals from the fish detection system and based on one or more signals from the biofouling detector.

FIG. 7 depicts a block diagram illustrating a data processing system suitable for performing a method according to an embodiment of the invention.

### DETAILED DESCRIPTION OF THE DRAWINGS

In the figures identical reference numerals indicate identical or similar elements.

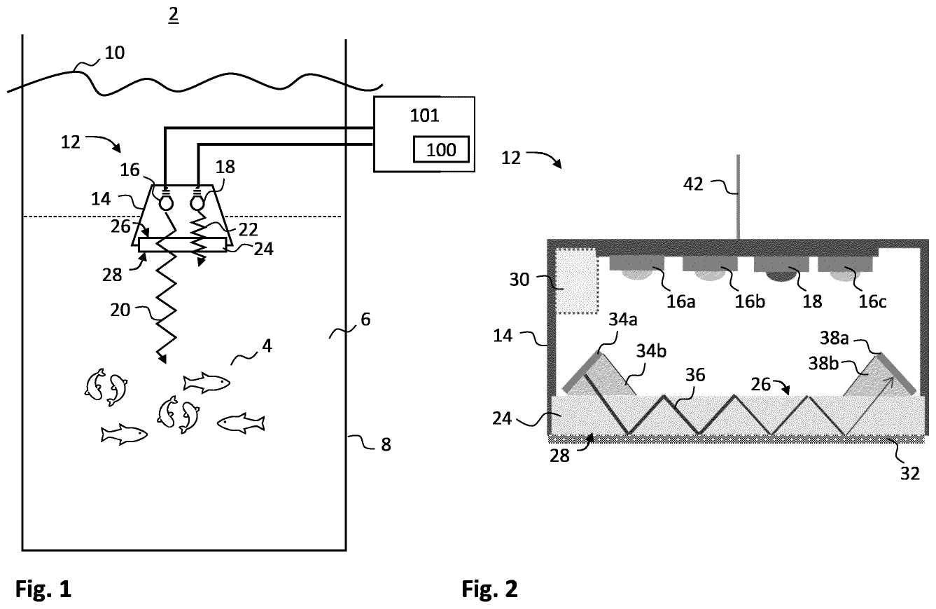

FIG. 1 schematically depicts an aquaculture lighting system 2 according to an embodiment. Such lighting system 2 is configured to influence physiological development of fish 4 in an enclosed area 6. Aquaculture lighting systems 2 may be employed in fish farms where fish 4 are grown for consumption. When the fish 4 reach a certain maturity they are harvested. Examples of such fish are salmon, tuna, carp fish, such as grass carp, silver carp, common carp, Roho labeo, Nile tilapia, milkfish, trout, et cetera. The enclosed area 6 may be an area within a sea, fjord, river or lake. However, the enclosed area may also be the area within a large on-land fish tank. Further, the enclosed area 6 is typically enclosed by nets or cage structures 8 or other fish barrier structures below the water surface 10 that are configured to keep the fish 4 inside the enclosed area 6.

The aquaculture lighting system 2 comprises a luminaire 12 and a control system 101. The luminaire 12 is submersible. Typically, the luminaire will be positioned approximately five meters under the water surface 10. The luminaire 12 comprises a luminaire housing 14 accommodating a grow light source 16 and an anti-fouling light source 18. The luminaire housing is watertight in order to prevent water from reaching the grow light source 16 or anti-fouling light source 18. Water may namely damage the light sources.

The grow light source 16 as well as the anti-fouling light source 18 may for example be Light Emitting Diodes (LEDs). These light sources may be configured to emit a predetermined light spectrum.

The grow light source is configured to generate grow light 20 suitable for influencing physiological development of fish. The grow light 20 typically comprises blue light having a wavelength between 400-470 nm and/or green light having a wavelength between 500-580 nm. The grow light 20 may be understood to influence the physical development of fish in that it may prevent fish from noticing the shortening of days.

The anti-fouling light source is configured to generate anti-fouling light 22 suitable for preventing biological fouling on and/or removing biological fouling from a surface. The anti-fouling light 22 may comprise ultraviolet light having a wavelength between 100-400 nm, preferably ultraviolet-C light having a wavelength between 100-280 nm, and/or blue light having a wavelength between 400-470 nm.

For UV-C light a typical dose required to remove biological fouling is for example 360-600 mJ/cm² at 254 nm. For blue light (400-470 nm) the typical light dose would need to be higher, for example 5-10 J/cm². It is remarked that the shorter wavelength light close to 400 nm is expected to be considerably more efficient than longer wavelength light close to 470 nm.

The grow light source 16 and the anti-fouling light source 18 are separately controllable and may as such be regarded as separate light sources.

The luminaire housing 14 comprises a transmissive part 24. The transmissive part 24 is sometimes referred to as the exit window of the luminaire and may comprise, e.g. essentially consist of, quartz glass and/or borosilicate and/or lime glass and/or sapphire and/or Poly(methyl methacrylate).

The transmissive part 24 comprises a first side 26 adjacent to an interior of the luminaire housing and a second side 28 adjacent to the environment outside of the luminaire housing. Thus, typically, the second side 28 is in contact with water as a result of which over time biological fouling forms on the second side 28. The transmissive part 24 is at least partially transparent for the grow light and for the anti-fouling light. Both the grow light and the anti-fouling light, which are generated inside the luminaire housing 15, should be able to exit the luminaire housing through the transmissive part 24 so that the grow light 20 can reach the fish 4 that are swimming in the enclosed area 6 and so that the anti-fouling light 22 can reach the second side 28 of the transmissive part. This allows the fish' physiological development to be indeed influenced by the grow light and to remove any biological fouling from the second side 28 of the transmissive part 24 and/or to prevent biological fouling on the second side 28 of the transmissive part 24.

The luminaire 12 is preferably configured to cause the anti-fouling light as generated by the anti-fouling light source to have, at 0.5 meters distance from the luminaire in the environment outside the luminaire housing, a radiant power, e.g. a radiant power per surface area, that is not harmful for said fish. To this end, the transmissive part 24 may have a certain characteristics, such as a certain thickness, and/or the anti-fouling light source may be configured to generate anti-fouling light 22 of a certain radiant power.

The luminaire 12 is preferably configured to cause the grow light as generated by the grow-light source to have, at 20 meters distance from the luminaire in the environment outside the luminaire housing, a radiant power, e.g. a radiant power per surface area, that is sufficient for influencing the physiological development of the fish. Again, to this end, the transmissive part may have certain characteristics, such as a certain thickness, and/or the grow light source may be configured to generated grow light 20 of a certain radiant power.

The control system 101 is configured to separately control the grow light source and the anti-fouling light source. The control system 101 may be embodied as a computer or any other data processing system. It should be appreciated that the control system 101 may be a distributed system in the sense that some elements of the control system 101 may be implemented in the luminaire and other elements may be implemented outside of the luminaire 12, for example outside of the enclosed area, such as implemented on a remote server, or implemented at a fish detection system, or biofouling detector.

The control system may be configured to control a radiant power of the anti-fouling light and/or to control when the anti-fouling light source generates anti-fouling light, such that biological fouling on the second side of the transmissive part is prevented.

Anti-fouling light may be generated periodically but preferably only at those times that most of the fish will not be illuminated by the anti-fouling light. This is to prevent that the light recipe will be compromised and/or that the fish will be harmed (especially in case the anti-fouling light contains UV). Typically, during feeding, the fish reside close to the surface. Therefore, during such times, the anti-fouling light can be generated. Hence, in one embodiment, the control system is configured to receive one or more signals from a feed system, the signals indicating that fish are being fed, and to, based on these one or more signals, control the anti-fouling light source, for example to start generate anti-fouling light or to increase a radiant power of the anti-fouling light as generated.

At typical configuration for outdoor salmon farming in sea cages comprises a sea cage of 25 m diameter, having 6 LED luminaires, each rated at 340 W and producing grow light of 150 lumens/W. This amounts to a grow light average level of typically 625 lumens/m² at the depth of the lamps.

FIG. 2 schematically depicts a luminaire 12 according to an embodiment. It consists of a water-tight luminaire housing 14 with a transmissive part 24, which may also be referred to as exit window, because the generated grow light and anti-fouling light exit through it. In the depicted embodiment, the luminaire housing 14 accommodates three grow light sources 16a, 16b and 16c and one anti-fouling light source 18. It should be appreciated that a light source as referred to herein may be a Light Emitting Diode (LED). The different grow light sources 16a, 16b, 16c may have similar or different light emission properties. Together, the grow light sources may provide a light level and spectrum as prescribed by a light recipe.

Typically, after some time, the exit window will become covered by biological fouling 32, typically consisting of algae, thereby reducing the light transmittance of the exit window. Next, this biofouling 32 will attract other organisms that will attach themselves to the biofilm 32, thereby reducing the transmittance even more. Especially during the initial stages of biofouling, it is still possible to clean the exit window with anti-fouling light.

The embodiment of FIG. 2 comprises a biological fouling detector, which, in the depicted embodiment, comprises a detection light source 34, which may comprise an LED 34a, for generating detection light 36. The detection light source 34 is arranged to couple the detection light 36 into the transmissive part 24 at an in-coupling surface. To this end the detection light source 34 may comprise an in-coupling prism 34b as shown. In the depicted embodiment, the biofouling detector also comprises a light detector 38, which may comprise a light sensitive element 38a, such as a photodiode, for measuring detection light 36, e.g. a radiant power of detection light, and arranged to measure said detection light 36 exiting the transmissive part 26 at an out-coupling surface. To this end, the light detector 38 may comprise an out-coupling prism 38b as shown. The transmissive part 24 is configured such that at least a first part of the detection light propagates through the transmissive part via total internal reflection between the first 26 and the second 28 surface of the transmissive part 24 and wherein biological fouling 32 at the second surface 28 of the transmissive part 24 causes at least a second part of the detection light to scatter and exit the transmissive part 24. In FIG. 2, this mechanism of part of the detection light 36 exiting the transmissive part 24 on its way to the light detector 38 is illustrated by the decreasing thickness of the arrow representing the detection light 36. This process may be regarded as an example of so-called frustrated total-internal-reflection. The radiant power detected by the light detector 38 has a relation with the amount of biofouling and therefore with the exit window transmittance. By means of calibration experiments, these relations can be determined.

The depicted biological fouling detector is merely one possible embodiment. Any system or element that can detect biofouling on the second side 28 of the transmissive part 24 may be regarded as a biofouling detector.

Preferably, the control system 101 (see FIG. 1) is configured to receive one or more signals from the biological fouling detector indicative of biological fouling 32 on the second side 28 of the transmissive part 24. The control system 101 and the biological fouling detector can for example communicate with each other through wired communication lines that may be present in cable 42. Note that cable 42 may also comprise lines for supplying electrical power to the light sources in the luminaire housing. Note that this power may be provided to the light sources via light source driver 30.

In any case, based on the one or more signals received from the biological fouling detector, the control system 101 can control the anti-fouling light source 18 to generate anti-fouling light for removing the detected biological fouling from the second side of the transmissive part.

Preferably, the biological fouling detector comprises a filter (not shown) for preventing grow light and/or anti-fouling light from reaching the light detector. Care has to be taken that grow light or anti-fouling is not coupled into the exit window (due to the presence of a biofilm or scratches in the exit window, for example) and subsequently detected by the detector 38. One solution to prevent this is to use a filter in front of the detector that filters out the grow light and anti-fouling light. Another solution may be to do the measurement when the grow light sources and/or anti-fouling light sources are switched off, e.g. during night-time.

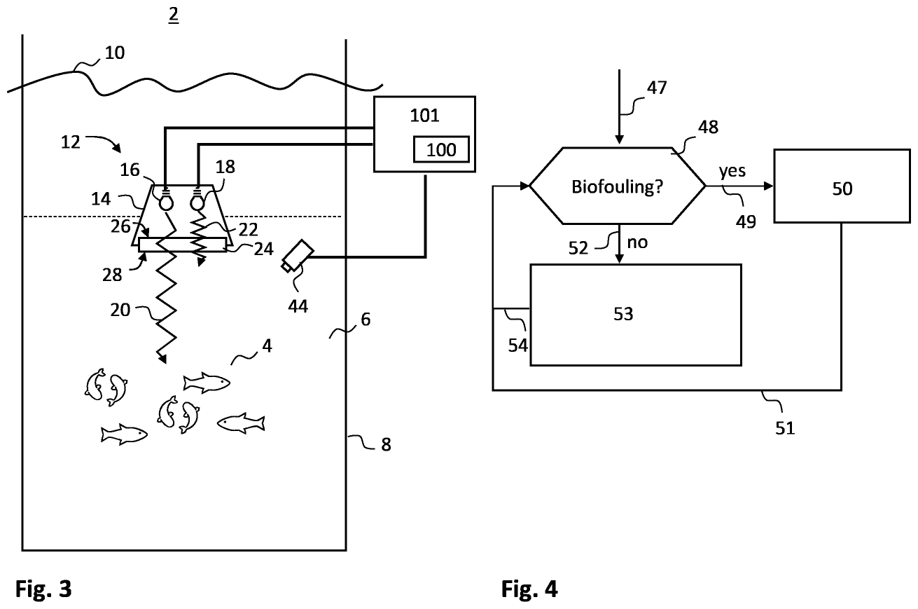

FIG. 3 schematically depicts an aquaculture lighting system according to an embodiment that comprises a fish detection system 44. The fish detection system 44 is configured to detect fish 4 near the luminaire 12. The fish detection system 44 may for example comprise a camera to detect fish. The camera may record images of the area near the luminaire. Subsequent image analysis may then be employed to detect whether fish are in the area near the luminaire. Additionally or alternatively, the fish detection system 44 may comprise a sonar system. In principle, any system or element that can detect fish near the luminaire 12 may be understood to be a fish detection system 44.

The control system 101 in this embodiment is configured to receive one or more signals from the fish detection system 44 indicating fish being present near and/or in front of the luminaire. These signals may be received via a wired communication connection between the control system 101 and/or via a wireless communication connection the fish detection system 44 and control system 101. The control system 101 is configured to, based on the received one or more signals from the fish detection system 44, control the anti-fouling light source 18 by controlling a radiant power of the anti-fouling light 22 as generated by the anti-fouling light source 18 and/or by controlling when the anti-fouling light source 18 generates anti-fouling light 22.

FIG. 4 is a flow chart illustrating a method for controlling a luminaire according to an embodiment. Such method may be understood to be performed by a control system 101 as described herein. Input to this method are one or more signals 47 from a biological fouling detector. Since the one or more signals 47 from the biological fouling detector are indicative of biological fouling on the second side, it can be determined 48 whether biological fouling is present on the second side. If it is or if the amount of biological fouling exceeds a threshold amount, then “yes” 49, step 50 is performed comprising generating anti fouling light for removing the detected biological fouling from the second side of the transmissive part. Then, see 51, the step 48 of determining whether biofouling is present on the second side can be determined again based on new signals 47. If no biological fouling is determined to be present on the second side or if the amount of detected biological fouling is lower than a threshold amount (output 52), then (step 53) the anti-fouling light source may be controlled to not generate anti-fouling light and/or to lower the radiant power of the generated anti-fouling light. Then (output 54) step 48 may be performed again based on new signals 47.

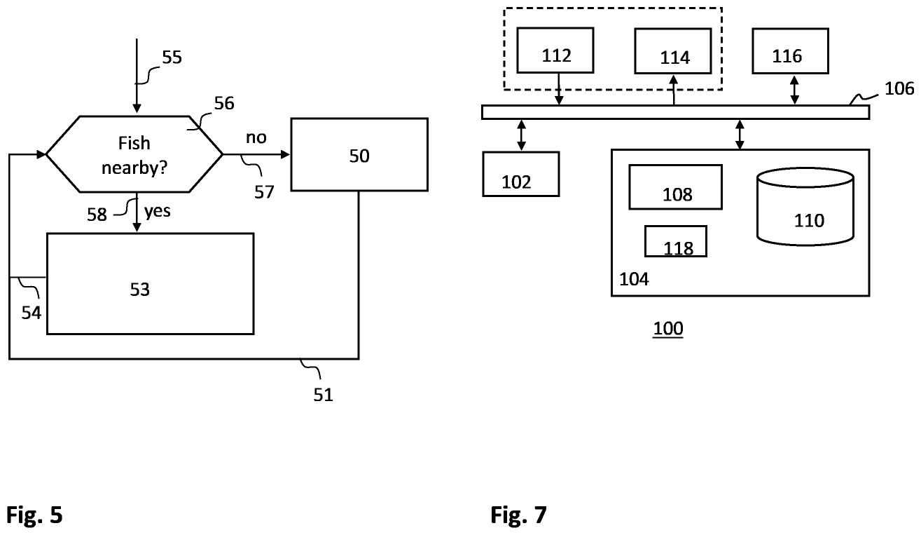

FIG. 5 is a flow chart illustrating a method for controlling a luminaire according to an embodiment. Such method may be understood to be performed by a control system 101 as described herein. Input to this method are one or more signals 55 from a fish detection system. Since the one or more signals 55 from the fish detection system are indicative of fish being present near and/or in front of the luminaire, it can be determined 56 whether fish are nearby. For example, whether fish are too close to the luminaire such that they will be harmed if the anti-fouling light source generates anti-fouling light. If no fish are present or only few fish (output 57), then “no”, step 50 is performed comprising generating anti-fouling light for removing the biological fouling from the second side of the transmissive part. Then (output 51) step 56 may be performed again based on new signals 55 from the fish detection system. If fish are detected near the luminaire (output 58), then step 53 is performed in that the anti-fouling light source may be controlled to not generate anti-fouling light and/or to lower the radiant power of the generated anti-fouling light. Then (output 54) step 56 may be performed again based on new signals 55 from the fish detection system. As used herein, fish being near the luminaire may be understood as that the fish are in a position where they would receive anti-fouling light, if generated, having an irradiance flux that would be harmful for the fish.

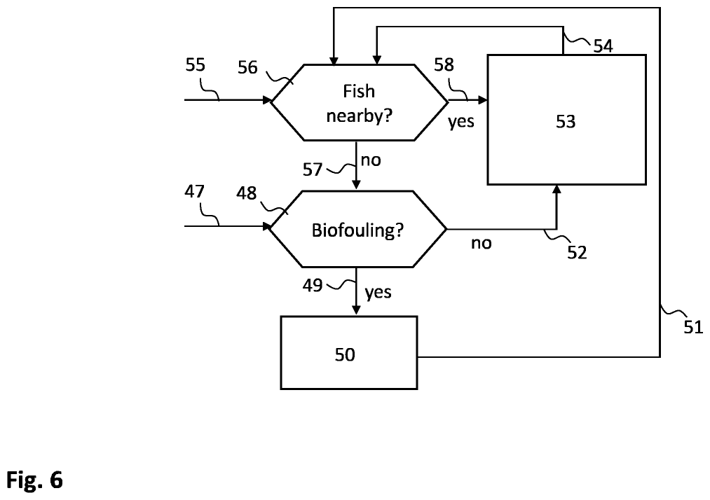

FIG. 6 is a flow chart illustrating a method for controlling a luminaire according to an embodiment. All steps here have already been described with reference to FIGS. 4 and 5. In this embodiment, the luminaire is controlled based on both one or more signals 55 from the fish detection system and on one or more signals 47 from the biological fouling detector.

FIG. 7 depicts a block diagram illustrating a data processing system according to an embodiment that may be implemented in a control system 101 described herein.

As shown in FIG. 7, the data processing system 100 may include at least one processor 102 coupled to memory elements 104 through a system bus 106. As such, the data processing system may store program code within memory elements 104. Further, the processor 102 may execute the program code accessed from the memory elements 104 via a system bus 106. In one aspect, the data processing system may be implemented as a computer that is suitable for storing and/or executing program code. It should be appreciated, however, that the data processing system 100 may be implemented in the form of any system including a processor and a memory that is capable of performing the functions described within this specification.

The memory elements 104 may include one or more physical memory devices such as, for example, local memory 108 and one or more bulk storage devices 110. The local memory may refer to random access memory or other non-persistent memory device(s) generally used during actual execution of the program code. A bulk storage device may be implemented as a hard drive or other persistent data storage device. The processing system 100 may also include one or more cache memories (not shown) that provide temporary storage of at least some program code in order to reduce the number of times program code must be retrieved from the bulk storage device 110 during execution.

Input/output (I/O) devices depicted as an input device 112 and an output device 114 optionally can be coupled to the data processing system. Examples of input devices may include, but are not limited to, a fish detection system as described herein, a biological fouling detector as described herein, a fish feeding system as described herein, a keyboard, a pointing device such as a mouse, a touch-sensitive display, or the like. Examples of output devices may include, but are not limited to, a grow light source as described herein, an anti-fouling light source as described herein, a monitor or a display, speakers, or the like. Input and/or output devices may be coupled to the data processing system either directly or through intervening I/O controllers.

A network adapter 116 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 100, and a data transmitter for transmitting data from the data processing system 100 to said systems, devices and/or networks. Modems, cable modems, and Ethernet cards are examples of different types of network adapter that may be used with the data processing system 100.

As pictured in FIG. 7, the memory elements 104 may store an application 118. In various embodiments, the application 118 may be stored in the local memory 108, the one or more bulk storage devices 110, or apart from the local memory and the bulk storage devices. It should be appreciated that the data processing system 100 may further execute an operating system (not shown in FIG. 7) that can facilitate execution of the application 118. The application 118, being implemented in the form of executable program code, can be executed by the data processing system 100, e.g., by the processor 102. Responsive to executing the application, the data processing system 100 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 102 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. An aquaculture lighting system for influencing physiological development of fish in an enclosed area, the aquaculture lighting system comprising:
a submersible luminaire comprising:
a luminaire housing accommodating a grow light source configured to generate grow light suitable for influencing physiological development of fish and accommodating an anti-fouling light source configured to generate anti-fouling light suitable for preventing biological fouling on and/or removing biological fouling from a surface, the grow light source and the anti-fouling light source being separately controllable, wherein
the luminaire housing comprises a transmissive part, the transmissive part comprising a first side adjacent to an interior of the luminaire housing and a second side adjacent to an environment outside of the luminaire housing, wherein
the transmissive part of the luminaire housing is at least partially transparent for the grow light and for the anti-fouling light; and
a control system configured to separately control the grow light source to generate the grow light and the anti-fouling light source to generate the anti-fouling light, thereby independently influencing physiological development of fish and preventing biological fouling on and/or removing biological fouling from the second side of the transmissive part.

2. The aquaculture lighting system according to claim 1, wherein
the anti-fouling light comprises ultraviolet light having a wavelength between 100-400 nm, ultraviolet-C light having a wavelength between 100-280 nm, and/or blue light having a wavelength between 400-470 nm.

3. The aquaculture lighting system according to claim 1, wherein the grow light comprises blue light having a wavelength between 400-470 nm and/or green light having a wavelength between 500-580 nm.

4. The aquaculture lighting system according to claim 1, wherein the transmissive part comprises quartz glass and/or borosilicate and/or lime glass and/or sapphire and/or Poly(methyl methacrylate).

5. The aquaculture lighting system according to claim 1, wherein the luminaire is configured to cause the anti-fouling light as generated by the anti-fouling light source to have, at 0.5 meters distance from the luminaire in the environment outside the luminaire housing, a radiant power, e.g. a radiant power per surface area, that is not harmful for said fish.

6. The aquaculture lighting system according to claim 1, wherein the luminaire is configured to cause the grow light as generated by the grow-light source to have, at 20 meters distance from the luminaire in the environment outside the luminaire housing, a radiant power, e.g. a radiant power per surface area, that is sufficient for influencing the physiological development of the fish.

7. The aquaculture lighting system according to claim 1, wherein the control system is configured to control a radiant power of the anti-fouling light and/or to control when the anti-fouling light source generates anti-fouling light, such that biological fouling on the second side of the transmissive part is prevented.

8. The aquaculture lighting system according to claim 1, further comprising:
a biological fouling detector for detecting biological fouling on the second side of the transmissive part, wherein the control system is configured to;
receive one or more signals from the biological fouling detector indicative of biological fouling on the second side of the transmissive part, and to
based on the one or more signals received from the biological fouling detector, control the anti-fouling light source to generate anti-fouling light for removing the detected biological fouling from the second side of the transmissive part.

9. The aquaculture lighting system according to claim 8, wherein the biological fouling detector comprises:
a detection light source for generating detection light and arranged to couple said detection light into the transmissive part at an in-coupling surface, and
a light detector for measuring detection light and arranged to measure said detection light exiting the transmissive part at an out-coupling surface,
wherein the transmissive part is configured such that at least a first part of the detection light propagates through the transmissive part via total internal reflection between the first and the second surface of the transmissive part and wherein biological fouling at the second surface of the transmissive part causes at least a second part of the detection light to scatter and exit the transmissive part.

10. The aquaculture lighting system according to claim 9, wherein the biological fouling detector comprises a filter for preventing grow light and/or anti-fouling light from reaching the light detector.

11. The aquaculture lighting system according to claim 1, comprising:
a fish detection system for detecting fish near the luminaire, wherein the control system is configured to
receive one or more signals from the fish detection system indicating fish being present near and/or in front of the luminaire, and to
based on the received one or more signals from the fish detection system, control the anti-fouling light source by controlling a radiant power of the anti-fouling light as generated by the anti-fouling light source and/or by controlling when the anti-fouling light source generates anti-fouling light.

12. A method for controlling a submersible luminaire of an aquaculture lighting system, the method comprising:
providing the submersible luminaire, wherein the submersible luminaire comprises a luminaire housing accommodating a grow light source configured to generate grow light suitable for influencing physiological development of fish and accommodating an anti-fouling light source configured to generate anti-fouling light suitable for preventing biological fouling on and/or removing biological fouling from a surface, the grow light source and the anti-fouling light source being separately controllable, wherein the luminaire housing comprises a transmissive part, the transmissive part comprising a first side adjacent to an interior of the luminaire housing and a second side adjacent to an environment outside of the luminaire housing, and wherein the transmissive part of the luminaire housing is at least partially transparent for the grow light and for the anti-fouling light; and
controlling the grow light source to generate the grow light and the anti-fouling light source to generate the anti-fouling light, thereby independently influencing physiological development of fish and preventing biological fouling on and/or removing biological fouling from the second side of the transmissive part.

13. The method according to claim 12, comprising:
receiving one or more signals from a biological fouling detector configured to detect biological fouling on the second side of the transmissive part, said one or more signals from the biological fouling detector being indicative of biological fouling on the second side of the transmissive part, and, based on the one or more signals received from the biological fouling detector, controlling the anti-fouling light source to generate anti-fouling light for removing the detected biological fouling from the second side of the transmissive part.

14. The method according to claim 12, comprising:
receiving one or more signals from a fish detection system indicating fish being present near and/or in front of the luminaire, and, based on the received one or more signals from the fish detection system, controlling the anti-fouling light source by controlling a radiant power of the anti-fouling light as generated by the anti-fouling light source and/or by controlling when the anti-fouling light source generates anti-fouling light.

15. A non-transitory computer readable medium comprising instructions which, when the instructions are executed by a data processing system of a control system, cause the data processing system to perform the method of claim 12.
